(19) United States
(12) Patent Application Publication
(10) Pub. No.: US 2006/0281856 A1
(43) Pub. Date: Dec. 14, 2006

(54) Quick set silicone based dental impression materials

(76) Inventors: Ralf Kollefrath, Ruthi (CH); Silvan Benz, Ruthi (CH)

Correspondence Address: KATTEN MUCHIN ROSENMAN LLP, 575 MADISON AVENUE, NEW YORK, NY, 10022-2585, US

(21) Appl. No.: 11/450,975

(22) Filed: Jun. 9, 2006

Related U.S. Application Data
(60) Provisional application No. 60/689,200, filed on Jun. 10, 2005.

(51) Int. Cl. C08G 77/00

(52) U.S. Cl. 524/588; 528/10

(57) ABSTRACT

A silicone material, preferably a multi-component addition-cured silicon impression compound, of at least one organopolysiloxane with at least two unsaturated groups in the molecule; at least one organohydrogenpolysiloxane with at least three SiH groups in the molecule; at least one platinum catalyst and at least one filler.

The present application claims benefit of U.S. Provisional Application No. 60/689,200 filed Jun. 10, 2005.

### BACKGROUND OF THE INVENTION

The present invention relates to compositions and methods for varying the components of a multi-component silicone material to result in an altered working period and/or an altered setting period.

In prosthodontics, impression materials of various types are used to form a mold of teeth or other oral structures. Dental impression materials are commonly composed of silicone materials that are stored until use in the dental office in a semi-finished manner. When required for use the two or more components of the impression material are combined, setting off a chemical reaction which in a short period of time changes the flowable character of the material to a hardened material. When the flowable material is applied to a structure such as a tooth it will harden to form an exact impression of that structure. The formed impression material can then be used in any number of conventional purposes.

Platinum catalyzed two component addition cure silicones are high tear strength, flexible, mold compounds. These silicones are, for example, modified polydimethylpolysiloxanes, as disclosed, for example, in U.S. Pat. No. 4,035,453, whose disclosure is incorporated herein and made a part hereof. One component contains a pre-polymer in which some of the methyl groups in the polydimethylpolysiloxanes are replaced by hydrogen. The other component contains a pre-polymer in which some of the methyl groups in the polydimethylpolysiloxanes are replaced by vinyl groups. A catalyst, typically a platinum catalyst, is present in the second component. When the two components are brought into contact crosslinking or polymerization occurs at a relatively rapid rate. During an initial working period, the components are readily mixed and the material remains relatively fluid. As polymerization occurs the viscosity of the mixture increases until it is complete and the silicone rubber is no longer fluid in typical use. This is the setting period.

In the dental office it is desirable to use materials that have a reasonably long working time so as to permit the proper mixing and application of the material to the dental structure whose impression is desired but which have a relatively short setting time so that once the material is applied it quickly sets, saving the dentist time and the patient discomfort.

One technique for increasing the working time has been to add a retarder to the mixture. Use of retarders with light-bodied addition silicones do increase the working time in many instances but result in degraded impressions and poorly fitted crowns fabricated from the impression. The compression set of retarded mixes reportedly increased four fold in some instances when removed at the recommended removal time and only an increase of removal time of approximately a minute resulted in a satisfactory compression set.

A formulation would be desirable that utilized a retarder in varying amounts but did not cause poor compression set or require extended setting times.

For the foregoing reasons, there is a two fold need existing in present dental impression materials—a need to provide an adequate, or even extended, working period and a very quick setting period.

### SUMMARY OF THE INVENTION

It is an object of the present invention to provide a two component silicone based impression material containing a multi-variant catalyst/crosslinker/retarder system utilizing a new retarder that meets the requirements of a dental impression material with flexible working and setting times. In particular, the new formulation significantly increases the rapidity of setting and permits a significant shortening of the time required to obtain an impression.

In one embodiment, a two component silicone based impression material is provided that has a working time that can be modified to suit the requirements of the dentist while retaining a short setting time. Accordingly, an object of the present invention is to provide a method and composition for dental impressioning that is flexible and convenient.

In two other preferred embodiments, the new two component silicone based impression material can be formulated to have a working time equal to that of conventional silicone impression materials and a shorter overall time from mixing to setting or the two component silicone based impression material can be formulated to provide an equivalent overall time as with conventional materials, in conjunction with a longer working time.

The foregoing objective is achieved in accordance with the present invention by use of compositions based on the surprising discovery that the working time, setting time, and therefore, the overall duration of the operation from start to recovery of a formed impression of an oral structure can be modified in a controlled manner by varying four components of the impression material formulation: 1] the SiHivinyl ratio, 2] the number of SiH groups in the crosslinker 3] the amount of catalyst and 4] the amount of an alkynol/alkyne retarder.

The object of the present invention is achieved by a silicone material containing (i) an amount of a first component which comprises at least one organopolysiloxane with at least two unsaturated groups, at least one organohydrogenpolysiloxane with at least three SiH groups, a retarder selected from the group consisting of alkynols having the formula R¹—C(OH)—C≡C—R² and alkynes having the formula R¹—C≡C—R², where R¹ is a C₁₋₂₀ alkyl group and R² is hydrogen or C₁₋₂ alkyl and, (ii) an amount of a second component which comprises at least one hydrosilylation catalyst, and at least one organopolysiloxane where the ratio of component (i) to component (ii) is variable to result in an altered working period and/or an altered setting period.

The present invention also provides compositions and methods for using compositions of a silicone material which includes an organopolysiloxane having at least three SiH groups; an organohydrogenpolysiloxane having at least three SiH groups, an alkynol/alkyne retarder, and a hydrosilylation catalyst.

A further object of the present invention is to provide a method for preparing a silicone material which includes the steps of: choosing a desired setting time and/or working time; mixing the components of the silicone material, comprising amounts of an organohydrogenpolysiloxane having at least three SiH groups, and a retarder; placing the mixture in contact with oral tissue; allowing the mixture to harden into an impression; and removing the impression from the oral tissue.

Also contemplated is a dental impression material and kits employing the dental impression material.

Still further embodiments of the invention provide for a kit containing different versions of each component and components contained in cartridges.

Other objects, features, and advantages of the invention will become apparent as the description thereof proceed when considered in connection with the accompanying illustrative drawing.

### DESCRIPTION OF THE FIGURE

FIG. 1 is a graph comparing the working and setting times of a prior art formulation (AFFINIS® LIGHT BODY, COLTENE WHALEDENT) with two formulations of the disclosed formulation according to the invention-Identical Setting Time (IST) and Identical Working Time (IWT).

### DETAILED DESCRIPTION OF THE INVENTION

The multi-variant silicone material utilizing an alkynol and/or alkyne retarder comprises a hydrogen modified polydimethylsiloxane, a vinyl modified polydimethylsiloxane, a catalyst, and a retarder; it may further comprise a crosslinker, filler and, optionally, other additives.

The formulation preferably is a multi-component, preferably two-component addition-crosslinking silicone impression material. One component, typically referred to as “base”, contains a silicone which has a number of the methyl groups substituted by hydrogen atoms. This first component also comprises at least one organopolysiloxane having at least two unsaturated groups in the molecule, at least one filler and an alkynol/alkyne retarder.

Prior to mixing, in a two component system, a first component preferably comprises, in weight percent of the first component:
from about 15 to about 60% by weight of at least one organopolysiloxane having at least two unsaturated groups in the molecule,
from about 1 to about 15% by weight of at least one organohydrogenpolysiloxane having at least three [3] SiH groups in the molecule,
from about 3 to about 80% by weight of at least one filler,
from about 0.005 to about 0.05% by weight of an alkynol or alkyne,
with this component exhibiting a viscosity in the range of from 0.5 to 500 Pa·s.

The second component, typically referred to as “catalyst” comprises a silicone material which has several of its methyl groups replaced by vinyl groups. Also present in the second component are at least one platinum catalyst and one or more fillers.

Prior to mixing, in a two component system, a second component preferably comprises, in weight percent of the second component
from about 20 to about 60% by weight of at least one organopolysiloxane having at least two unsaturated groups in the molecule,
from about 0.005 to about 0.01% by weight of at least one hydrosilylation catalyst, preferably at least one platinum catalyst, most preferably a Pt(0) complex (calculated as elemental metal),
from about 3 to about 80% by weight of at least one filler,
   with this component exhibiting a viscosity in the range of from 0.5 to 500 Pa·s.

In one embodiment, the two components are employed in a volume ratio which is in the range from about 1:1 to about 1:100, more preferably in the range from about 1:1 to about 1:10 and particularly preferably in the range from about 1:1 to about 1:2.

After mixing, the composition comprises, in weight percent of the total composition:

| | Workable | | |
|---|---|---|---|
| Component | Range | Preferred | Most Preferred |
| Hydrosilylation catalyst | 1-200 ppm | 20-150 ppm | 50-100 ppm |
| Retarder | 1-500 ppm | 20-350 ppm | 50-200 ppm |
| Filler | 3-80% | 25-75% | 35-70% |
| Polydialkylsiloxanes (total) | 97-20% | 75-25% | 65-30% |
| Divinylpolydialkylsiloxanes | 1.00-2.50 | 1.30-2.20 | 1.50-1.80 |
| and crosslinkers in a | | | |
| SiH/vinyl ratio | | | |
| Additives (pigments, | variable | variable | variable |
| surfactants, modifiers) | | | |

One or more linear diorganovinylsiloxy-terminated polydiorganosiloxanes, preferably one or more linear dimethylvinylsiloxy-terminated polydimethylsiloxanes having differing viscosities are preferred in certain embodiments of the invention.

Silicones

The organopolysiloxane having hydrogen moieties in the molecule can consist of one or more organopolysiloxanes which differ from each other. It is likewise possible for the organopolysiloxane having vinyl groups to contain one or more organopolysiloxanes which differ from each other. Preferred unsubstituted diorganopolysiloxanes of this structure are depicted by the following formula
CH₂═CH(—SiR₂—O)ₙ—SiR₂—CH═CH₂
where R represents an unsubstituted or substituted monovalent hydrocarbon group which is preferably free from aliphatic multiple bonds, and n represents an integer and exhibits a Brookfield viscosity in the range from 0.05 to 1000 Pa·s, characterized in that, in the mixed state, the silicone impression material exhibits a consistency according to one of the four types defined in ISO 4823:2000.

In a preferred embodiment, at least 50% of the radicals R are methyl groups. R may also be ethyl, vinyl, phenyl or 3,3,3-trifluoropropyl groups. The value of n is preferably selected such that the polymer has a viscosity at 25° C. which is in the range of from 25 to 500,000 mPa·s. Molecules of this nature are described, for example, in U.S. Pat. No. 4,035,453, the entire disclosure of which is incorporated by reference into the present application.

The silicones are prepared using customary methods which are described, for example, in W. Noll, “Chemie und Technologie der Silikone” (Chemistry and Technology of the Silicones)”, Verlag Chemie Weinheim, 2nd Edition 1964, pages 162-206.

The composition of an impression material can vary in a very broad range depending on the physical properties wanted such as low viscous light body vs. high viscous putty. For this reason the ranges provided herein are given for the most typical range of properties desired by dental practitioners and are not intended to be limit the invention to solely those ranges.

As used herein, the term “crosslinker” refers to an organopolysiloxane having at least three Si-bonded hydrogen atoms per molecule.

Preferably, this organopolysiloxane contains from 0.01 to 1.7% by weight of Si-bonded hydrogen atoms, and the silicon valences not satisfied by hydrogen atoms, or siloxane oxygen atoms are satisfied by unsubstituted or substituted monovalent hydrocarbon radicals free of aliphatic multiple bonds, at least 50 percent of the hydrocarbon radicals bonded to silicon atoms carrying hydrogen atoms being methyl radicals.

Retarders

As used herein, the term “retarder” refers to chemical compounds or moieties that delay the set time.

Suitable retarders for the present invention include, but are not limited to, 1,3,5,7-tetravinyltetramethylcyclotetrasiloxane and 1,3-divinyltetramethyldisiloxane (DVTMDS). This compound is added to the formulation as such, or it may be combined with a platinum to form Karstedt's catalyst (Pt/DVTMDS) or it may be added in both forms. Although it is possible to vary the working time of the formulation through the use of prior art retarders and other components, the setting time is not greatly variable with prior art retarders.

The preferred new retarder compounds are various alkynes or alkynols that allow a substantial shortening of the setting time. They react with the SiH moieties in the formulation and are fixed into the polymer. The preferred retarders are alkynols having the formula R¹—C(OH)—C≡C—R² where R¹ may be 1 to 20 carbons, branched, cyclic, linear, or combinations thereof, preferably where R¹═C₁₋₁₅, most preferably where R¹═C₂₋₁₀ and R² may be hydrogen or C₁₋₂. This is approximately the widest workable range because as the chain increases in length and molecular weight, the materials become solid and are more difficult to dissolve or disperse into the silicone. A preferred alkynol for use in the present invention is ethyl octynol,
CH₃(CH₂)₃CH(C₂H₅)CH(OH)C≡CH.

The alternatives are alkynes of the formula R¹—C≡C—R² with the same carbon chain limits.

Retarder concentrations range from about 1 to about 500 ppm, preferably from about 20 to about 350 ppm and most preferably from about 50 to about 200 ppm in the impression material.

Surprisingly, the compositions according to the invention allow for a great variety of reaction profiles (and resulting working times and setting times, respectively) to be adjusted, without any further heating step being necessary in order to allow the composition to cure.

Catalyst

As used herein “catalyst” refers to a chemical compound or moiety that catalyzes the hydrosiliation reaction.

Suitable catalysts include, but are not limited to, catalysts for hydrosilylation reactions at room temperature known to the experienced formulator. Preferred are catalysts of the platinum metals group, preferably platinum catalysts such as hexachloroplatinic acid and Karstedt-catalyst.

For at least the two common catalysts (hexachloroplatinic acid and Karstedt-catalyst) it is common to utilize the catalyst in an amount in the range from 1 to 200 ppm, preferably from 20 to 150 ppm, and particularly preferably in a range from 50 to 100 ppm.

In one embodiment for varying the proportions of the components most active in determining working and setting time, the catalyst is held to a level of approximating 100 ppm of the final composition. Utilizing this amount of catalyst as a constant, setting behavior can then be modified within desired limits by varying the final formulation, the appropriate amounts of the retarders according to the invention, the ratio of vinyl- and SiH-groups and/or the total amount of vinyl groups in the formulation.

A change between the hexachloroplatinic acid and Karstedt-catalyst results in a linear relationship (amount of platinum). However, due to the handling and solubility advantages Karstedt-catalyst is widely preferred in the dental industry.

Fillers

As used herein the term “filler” refers to “any inert material or composition added to a formulation to add bulk to a formulation.

Fumed pyrogenic silica is an exceptionally pure form of silicon dioxide manufactured by heating silicon tetrachloride in an oxy-hydrogen flame. Particle sizes typically range from 0.0007 to 0.05 μm. When used in a composition with polydiorganosiloxanes it interacts strongly with the siloxane chain and can increase the tensile strength of the resulting polymer by a factor of as much as ten.

Suitable fillers for use in the invention include, but are not limited to, non-reinforcing fillers having a BET surface of up to 50 m²/g, such as quartz, cristobalite, calcium silicate, zirconium silicate, montmorillonites, bentonites, zeolites including molecular sieves, metal oxide powders, barium sulfate, calcium carbonate, gypsum and glass and plastic powders. Preferred fillers include quartz, cristobalite and sodium aluminum silicates, especially when surface-treated. The fillers may have a surface area up to about 50 m²/g; preferred fillers exhibit a BET surface area of up to 15 m²/g.

Other fillers, such as reinforcing fillers having a BET surface area of greater than 50 m²/g, preferably up to about 15 m²/g such as pyrogenic or precipitated silicic acid or silicon aluminum mixed oxides are also suitable for use.

Both reinforcing and nonreinforcing fillers may be utilized, with, for example, at least one reinforcing filler being present in one of the components and at least one nonreinforcing filler being present in the other component. It is likewise also possible for reinforcing and nonreinforcing filler to be present together in one single component or to be present in both components, with it being possible for reinforcing fillers which are different from each other, or different nonreinforcing fillers, to be present in the different components.

The fillers can be surface-treated and, in this connection, preferably hydrophobized, for example by being treated with organosilanes or organosiloxanes or by hydroxyl groups being etherified to give alkoxy groups. The fillers are present in the impression material in a proportion in the range from 0 to 80% by weight, preferably in a range from 25 to 75% by weight and particularly preferably in a range from 30 to 65% by weight of the total composition.

Surfactants

As used herein “surfactants” refer to components in the formulation to reduce the surface tension of the components and to facilitate mixing. The formulation must be able to displace moisture on the tooth and should make intimate contact with the structure whose image is being obtained. Increased wettability through the use of surfactants is highly desirable. A useful surfactant is TERGITOL NP-4™ manufactured by DOW.

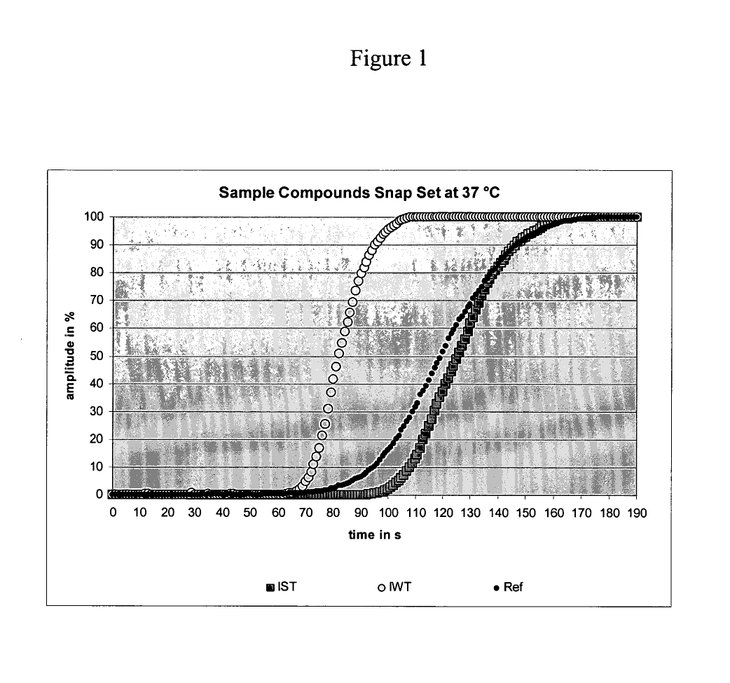

The working time is measured with a self-made device and a method, both according to ISO 4823:2000 (www.iso.org). The Maximum working time is reached when the curve shows first elastic behavior of the material. Setting time is measured with an oscillating rheometer (BRABENDER CYCLO-VISCO®), providing a curve as in FIG. 1. The setting time is the point where the slope of the curve reaches zero and the amplitude is set at its maximum. All the amplitudes in FIG. 1 are normalized to a maximum of 100%.

### EXAMPLES

The following chart records the results obtained when the prior art formulation is compared to the newly disclosed formulation (WT=working time; ST=setting time).

| | Example 1 Affinis Light | | | | | |
|---|---|---|---|---|---|---|
| | Body ® | | Example 2 Identical ST | | Example 3 Identical WT | |
| | (Coltene Whaledent) | | (Setting Time) | | (Working Time) | |
| | WT = 149 s | ST = 179 s | WT = 210 s | ST = 175 s | WT = 140 s | ST = 117 s |
| Component/Time | Base in g | Catalyst in g | Base in g | Catalyst in g | Base in g | Catalyst in g |
| Divinylpolydimethylsiloxane | 15.000 | 17.950 | 13.496 | 17.955 | 13.499 | 17.955 |
| (1 Pas, 0.14 mmol/g Vinyl) | | | | | | |
| [Silopren U1, GE Bayer] | | | | | | |
| Divinylpolydimethylsiloxane | 2.500 | 2.500 | | 2.501 | | 2.501 |
| (0.2 Pas, 0.3 mmol/g Vinyl) | | | | | | |
| [Silopren U0.2, GE Bayer] | | | | | | |
| Crosslinker (40 mPas, 4.2 mmol/g | 2.500 | | | | | |
| SiH, 13 SiH) | | | | | | |
| [Silopren U Vernetzer 430, | | | | | | |
| GE Bayer] | | | | | | |
| Crosslinker (60 mPas, 1.8 mmol/g | | | 6.498 | | 6.499 | |
| SiH, 7 SiH) | | | | | | |
| [experimental] | | | | | | |
| Quartz powder, silanized | 30.000 | 27.265 | 29.991 | 27.273 | 29.997 | 27.273 |
| [Silbond 8000 RST, | | | | | | |
| Quarzwerke] | | | | | | |
| Pt-catalyst (0.15% Pt) | | 2.270 | | 2.271 | | 2.271 |
| [Karstedt-catalyst diluted in | | | | | | |
| Silopren U1/quartz filler, | | | | | | |
| made in-house] | | | | | | |
| DVTMDS | | 0.015 | | | | |
| [Divinyltetramethyldisiloxane, | | | | | | |
| Aldrich] | | | | | | |
| Alkynol [Ethyloctynol, BASF] | | | 0.015 | | 0.005 | |
| Total | 50.000 | 50.000 | 50.000 | 50.000 | 50.000 | 50.000 |

WT measured at 23° C.,
ST at 37° C.;
WT can be longer than ST

In example 1, the crosslinker is a polydimethylsiloxane in which 13 of the methyl groups have been substituted by hydrogen. The Pt-catalyst paste is a catalyst paste obtained from Karstedt-catalyst diluted with Silopren Ul a vinyl modified dimethypolysiloxane [GE Bayer Silicones, Leverkussen, Germany],/quartz filler. The DVTMDS is obtained from Aldrich.

In example 2, the crosslinker is a polydimethylsiloxane in which 7 of the methyl groups have been substituted by hydrogen. The retarder is ethyloctynol obtained from BASF. The setting time is identical to example 1, the working time is prolonged by almost a minute or 40%. This demonstrates flexibility of the system and the additional working time permitted while obtaining the same setting time.

In example 3, the amount of retarder compared to example 2 is varied, so the working time is identical to example 1, the setting time is reduced by almost a minute or 33%. This system allows faster impression taking without compromising the working time.

As can be seen from the examples, substitution of the alkynol for the conventional retarder causes a reduction of the setting time, as illustrated in FIG. 1 where the steepness of the curve during setting clearly illustrates the time saving effect (“snap set”) of substituting the alkynol/alkyne retarder for the conventional DVTMDS retarder.

Referring to FIG. 1, and the steepness of the curve, there is shown a lengthening of the working time from that of the reference.

Variable concentrations of retarder and crosslinker do not relate in simple accordance to a mathematical law which can predict the working and setting time behavior of a formulation. It will be understood that various modifications of the variables of vinyl/SiH ratio, the number of SiH groups in the crosslinker, catalyst concentration and alkynol/alkyne retarder will provide equivalent results and other modifications will provide results in various portions of the disclosed ranges as desired by the practitioner.

The present invention is useful in the field of dentistry including forensic odontology; e.g., dental identifications and in the area of dental chartings. Moreover, it can also be used for preservation of patterns such as fingerprints for forensic purposes as well as other uses where impression material is used.

The kits or parts according to the present invention may comprise parts for mixing a silicone material with a first component which comprises at least one organopolysiloxane with at least two unsaturated groups, at least one organohydrogenpolysiloxane with at least three SiH groups, and a retarder selected from the group consisting of alkynols having the formula R¹—C(OH)—C≡C—R² and alkynes having the formula R¹—C≡C—R², wherein R¹ is a C₁₋₂₀ alkyl group and R² is hydrogen or C₁₋₂ alkyl; and a second component which comprises at least one hydrosilylation catalyst, and at least one organopolysiloxane, the amount of the retarder and/or the amount of the organohydrogenpolysiloxane with at least three SiH groups in the mixed silicon material is variable, thereby adjusting the working period and the setting period of the silicon material. In one embodiment, the silicone material comprises a multi-component dental impression composition. In another embodiment, the kit contains a plurality of different versions of the first component and a plurality of the second component, each containing different amounts of retarder and/or the amount of the organohydrogenpolysiloxane with at least three SiH groups.

In yet another embodiment, the kit of the invention may contain at least two different versions of the first component in cartridges.

While certain preferred and alternative embodiments of the invention have been set forth for purposes of disclosing the invention, modification to the disclosed embodiments can occur to those who are skilled in the art. Accordingly, the appended claims are intended to cover all embodiments of the invention and modifications thereof, which do not depart from the spirit and scope of the invention.

We claim:

1. A silicone material comprising (i) an amount of a first component which comprises at least one organopolysiloxane with at least two unsaturated groups, at least one organohydrogenpolysiloxane with at least three SiH groups, a retarder selected from the group consisting of alkynols having the formula R¹—C(OH)—C≡C—R² and alkynes having the formula R¹—C≡C—R², wherein R¹ is a C₁₋₂₀ alkyl group and R² is hydrogen or C₁₋₂ alkyl and, (ii) an amount of a second component which comprises at least one hydrosilylation catalyst, and at least one organopolysiloxane wherein the ratio of component (i) to component (ii) is variable to result in an altered working period and/or an altered setting period.

2. The material as in claim 1 wherein the silicone material is a dental impression material.

3. The silicone material as in claim 1 wherein the organohydrogenpolysiloxane has between 3 to 5 SiH groups.

4. The silicone material as in claim 1 wherein the organohydrogenpolysiloxane has between 4 to 11 SiH groups.

5. The silicone material as in claim 4 wherein the organohydrogenpolysiloxane has between 5 to 8 SiH groups.

6. The silicone material as in claim 1 further comprising one or more ingredients selected from the group consisting of fillers, surfactants, additives, and combinations thereof.

7. The silicone material as in claim 1 wherein the first component and the second component are present in a volume ratio of about 1:1 to about 1:10.

8. The silicone material as in claim 7 wherein the first component and the second component are present in a volume ratio of about 1:1 to about 1:2.

9. The silicone material as in claim 1 wherein the first component and the second component each have a viscosity of about 0.5 to about 500 Pa·s.

10. A silicone material comprising:
(i) at least one organopolysiloxane having at least two unsaturated groups;
(ii) at least one organohydrogenpolysiloxane having at least three SiH groups;
(iii) a retarder selected from the group consisting of alkynols having the formula R¹—C(OH)—C≡C—R² and alkynes having the formula R¹—C≡C—R², wherein R¹ is a C₁₋₂₀ alkyl group and R² is hydrogen or C₁₋₂ alkyl and,
(iv) at least one hydrosilylation catalyst;
wherein the working time and the setting time are modified in a controlled manner by varying any of (i)-(iv), a ratio of vinyl to SiH groups, a total amount of vinyl groups, or any combination thereof.

11. The material as in claim 10 wherein the silicone material is a dental impression material.

12. The silicone material as in claim 10 wherein said first component comprises:
about 15% to about 60% by weight of organopolysiloxane;
about 1% to about 15% by weight of organohydrogenpolysiloxane having at least three SiH groups; and
about 0.005% to about 0.05% of the retarder selected from the group consisting of alkynols having the formula R¹—C(OH)—C≡C—R²; and alkynes having the formula R¹—C═C—R²;
wherein R¹ is a C₁₋₂₀ alkyl group and R² is hydrogen or a C₁₋₂ alkyl group; and
said second component comprises:
about 20% to about 60% by weight of organopolysiloxane; and
about 0.005 to about 0.01% the hydrosilylation catalyst.

13. The silicone material as in claim 10 further comprising one or more ingredients selected from the group consisting of fillers, surfactants, additives, and combinations thereof.

14. The silicone material as in claim 6 comprising about 3% to about 80% by weight of filler in each of the first and second components.

15. The silicone material as in claim 10 wherein said hydrosilylation catalyst is a platinum catalyst.

16. The silicone material as in claim 15 wherein said hydrosilylation catalyst is selected from the group consisting of hexachloroplatinic acid, Karstedt-catalyst, a Pt(0) complex with vinylsiloxan ligands, and combinations thereof.

17. The silicone material as in claim 15 wherein said hydrosilylation catalyst is a Pt(0) complex with vinylsiloxan ligands.

18. The silicone material as in claim 10 wherein the alkynol retarder is ethyl octynol.

19. The silicone material of claim 10 wherein the ratio of organopolysiloxane to retarder is from about 20,000:1 to about 200:1.

20. The silicone material of claim 10 comprising a SiH/vinyl ratio between about 1.00 to about 6.00.

21. The silicone material of claim 20 comprising a SiH/vinyl ratio between about 1.5 to about 3.5.

22. The silicone material of claim 21 comprising a SiH/vinyl ratio between about 1.5 to about 2.5.

23. The silicone material as in claim 10, having a working time at 23° C. of at least 0.5 minutes, measured according to ISO 4823:2000, and a setting time at 37° C., measured according to ISO 4823:2000, wherein the setting time is shorter than or equal to the working time.

24. The silicone material as in claim 10, wherein the organopolysiloxane comprises at least one vinyl-modified polydimethylsiloxane.

25. The silicone material as in claim 10, wherein the organohydrogenpolysiloxane comprises at least one hydrogen-modified polydimethylsiloxane.

26. A method of individually varying a working time and/or a setting time of a multi-component silicone material in a controlled manner, wherein the silicone material comprises an organohydrogenpolysiloxane with at least three SiH groups, and a retarder selected from the group consisting of alkynols having the formula R¹—C(OH)—C≡C—R² and alkynes having the formula R¹—C≡C—R², wherein R¹ is a C₁₋₂₀ alkyl group and R² is hydrogen or C₁₋₂ alkyl, said method comprising the step of:
varying the amount of retarder.

27. The method of claim 26 wherein the silicone material comprises a multi-component dental impression composition.

28. The method of claim 26, wherein the setting time is shortened while the working time is unchanged.

29. The method of claim 26, wherein the working time is prolonged while the setting time is unchanged.

30. A method of varying a setting time of a silicone material in a controlled manner, said method comprising the steps of:
maintaining the amount of catalyst constant; and
varying the ratio of vinyl and SiH groups and/or varying the total amounts of vinyl groups.

31. The method of claim 30 where the silicone material comprises a multi-component dental impression composition.

32. A method of varying a setting time of a silicone material in a controlled manner, said method comprising the step of:
varying the number of SiH groups in the organohydrogenpolysiloxane.

33. A method of reducing the setting time of a silicone material while maintaining the working time of said composition; and/or extending the working time of a multi-component dental composition while maintaining the setting time of said composition, wherein an alkynol, of the general formula R¹—C(OH)—C≡C—R²; and/or an alkyne, of the general formula R¹—C≡C—R², wherein R¹ is a C₁₋₂₀ alkyl group and R² is hydrogen or a C₁₋₂ alkyl group, is added to the multi-component dental impression composition.

34. A method for preparing a silicone material comprising:
(i) choosing a desired setting time and/or working time;
(ii) mixing the components of the silicone material, comprising amounts of an organohydrogenpolysiloxane having at least three SiH groups, and a retarder selected from the group consisting of alkynols having the formula R¹—C(OH)—C≡C—R² and alkynes having the formula R¹—C≡C—R², wherein R¹ is a C₁₋₂₀ alkyl group and R² is hydrogen or C₁₋₂ alkyl, depending on the choice made in step (i);
(iii) placing said mixture in contact with oral tissue;
(iv) allowing said mixture to harden into an impression; and
(v) removing said impression from said oral tissue.

35. The method of claim 26 wherein the amount of retarder ranges from about 1 to about 1000 ppm, and the setting time is reduced by at least 30% when compared to the same overall composition but using the same amount of DVTMDS retarder instead of the said alkynol and/or alkyne retarder.

36. A dental impression made by the method of claim 26.

37. In a method for the production of a multicomponent silicone material wherein the first component is combined with the second component, the improvement comprising adding varying amounts of retarder to modify the working and setting times.

38. A kit of parts for mixing a silicone material comprising:
(i) a first component which comprises at least one organopolysiloxane with at least two unsaturated groups, at least one organohydrogenpolysiloxane with at least three SiH groups, and a retarder selected from the group consisting of alkynols having the formula R¹—C(OH)—C≡C—R² and alkynes having the formula R¹—C≡C—R², wherein R¹ is a C₁₋₂₀ alkyl group and R² is hydrogen or C₁₋₂ alkyl; and
(ii) a second component which comprises at least one hydrosilylation catalyst, and at least one organopolysiloxane,
wherein the amount of the retarder and/or the amount of the organohydrogenpolysiloxane with at least three SiH groups in the mixed silicon material is variable, thereby adjusting the working period and the setting period of said silicon material.

39. The kit of claim 38 wherein the silicone material comprises a multi-component dental impression composition.

40. The kit of claim 38, wherein a plurality of different versions of component (i) are provided together with a plurality of component (ii) each comprising different amounts of said retarder and/or the amount of the organohydrogenpolysiloxane with at least three SiH groups.

41. The kit of claim 38, wherein the at least two different versions of component (i) are contained in cartridges.
